(19) United States
(12) Patent Application Publication
(10) Pub. No.: US 2025/0121659 A1
(43) Pub. Date: Apr. 17, 2025

(54) SLIDE DOOR DEVICE

(71) Applicants: AISIN CORPORATION, Kariya (JP); TOYOTA JIDOSHA KABUSHIKI KAISHA, Toyota-shi (JP)

(72) Inventors: Takayoshi SUZUKI, Kariya-shi (JP); Toshitsugu Oda, Kariya-shi (JP); Hisashi Itonaga, Kariya-shi (JP); Takashi Sasaki, Miyoshi-shi (JP); Junya Nogami, Toyota-shi (JP); Kouichi Ishiwaki, Kariya-shi (JP); Nobuo Hayama, Kariya-shi (JP); Yuusuke Katou, Kariya-shi (JP)

(73) Assignees: AISIN CORPORATION, Kariya (JP); TOYOTA JIDOSHA KABUSHIKI KAISHA, Toyota-shi (JP)

(21) Appl. No.: 18/894,899

(22) Filed: Sep. 24, 2024

(30) Foreign Application Priority Data
Oct. 11, 2023 (JP) 2023-175802

(51) Int. Cl. B60J 5/06; E05B 15/02; E05B 83/40

(52) U.S. Cl. CPC B60J 5/06; E05B 15/0205; E05B 83/40

(57) ABSTRACT

In a slide door device including a slide door that opens and closes a door opening formed at a side face of a vehicle body by sliding the door opening in a front-rear direction of the vehicle body, the slide door device includes a striker fixed to an opening edge of the door opening, and a first latch that is fixed to an end of the slide door, the end facing the opening edge, when the slide door is fully closed, is pressed by the striker to rotate when the slide door is fully closed, and is engageable with a leg of the striker in a direction from a vehicle interior side toward a vehicle exterior side.

### CROSS REFERENCE TO RELATED APPLICATIONS

This application is based on and claims priority under 35 U.S.C. § 119 to Japanese Patent Application No. 2023-175802, filed on Oct. 11, 2023, the entire content of which is incorporated herein by reference.

### TECHNICAL FIELD

The present disclosure discloses a slide door device.

### BACKGROUND DISCUSSION

In the related art, as this type of slide door device including a slide door that opens and closes a door opening, there has been proposed a slide door device including a front end opening formed at a front end face of the slide door, a hook member having an engagement claw and rotatably attached to the front end of the slide door, a pressing member that is disposed on a vehicle interior side of the slide door and rotates the hook member with displacement to a vehicle exterior side to protrude the engagement claw from the front end opening, a vehicle body side opening formed at a front side edge of the door opening (rear end face of a pillar), and a locking member that is stored in the vehicle body side opening and with which the engagement claw protruding from the front end opening is engaged (see, for example, JP 2019-64369 A). In this device, the displacement of the front end of the slide door toward the vehicle exterior side can be regulated, and the opening of the slide door can be suppressed.

In the slide door device described above, the hook member is not locked to the locking member unless the pressing member provided at the slide door is displaced from the vehicle interior side to the vehicle exterior side. For this reason, depending on a place where the slide door is pushed, there is a possibility that the hook member does not operate and displacement of the slide door from the vehicle interior side to the vehicle exterior side cannot be regulated.

A need thus exists for a slide door device which is not susceptible to the drawback mentioned above.

### SUMMARY

In a slide door device including a slide door that opens and closes a door opening formed at a side face of a vehicle body by sliding the door opening in a vehicle front-rear direction, the slide door device includes a striker fixed to an opening edge of the door opening, and a first latch that is fixed to an end of the slide door, the end facing the opening edge, when the slide door is fully closed, is pressed by the striker to rotate when the slide door is fully closed, and is engageable with a leg of the striker in a direction from a vehicle interior side toward a vehicle exterior side.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a vehicle including a slide door device;

FIG. 2 is a plan view of the slide door device when fully opened when viewed in the vertical direction of the vehicle;

FIG. 3 is a plan view of the slide door device when fully closed when viewed in the vertical direction of the vehicle;

FIG. 4 is a partially enlarged view of the slide door device of FIG. 2;

FIG. 5 is a partially enlarged view of the slide door device of FIG. 3;

FIG. 6 is a top view of the upper hook device;

FIG. 7 is a side view of the upper hook device;

FIG. 8 is a partially enlarged view of a striker engaged with the upper hook device; and

FIGS. 9A to 9D are explanatory views illustrating a state of the operation of the upper hook device.

### DETAILED DESCRIPTION

Embodiments for carrying out the present disclosure will be described with reference to the drawings.

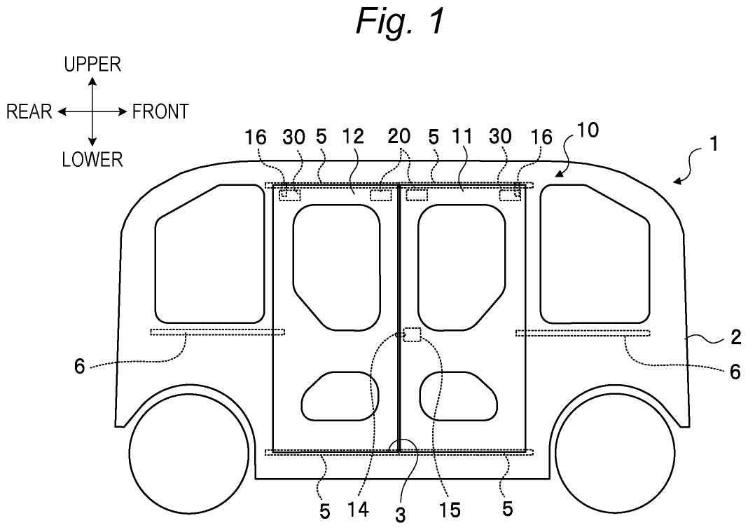

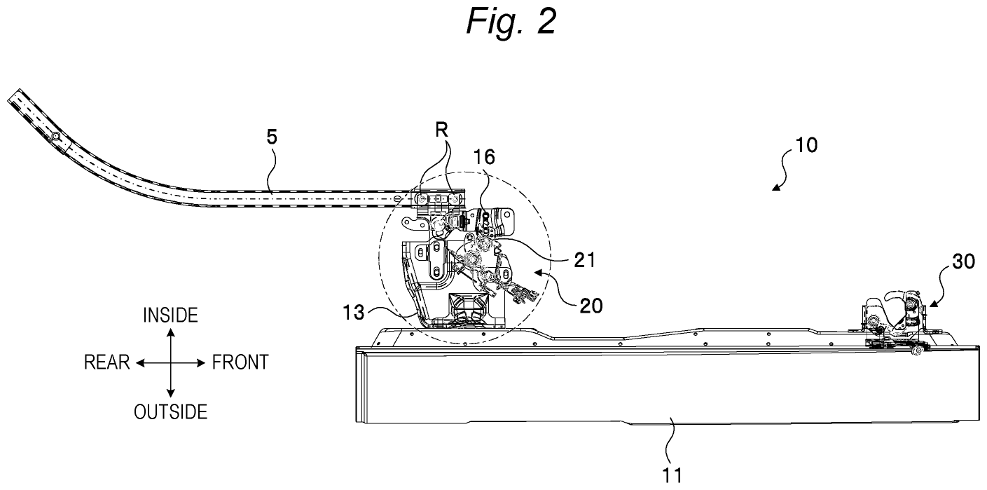

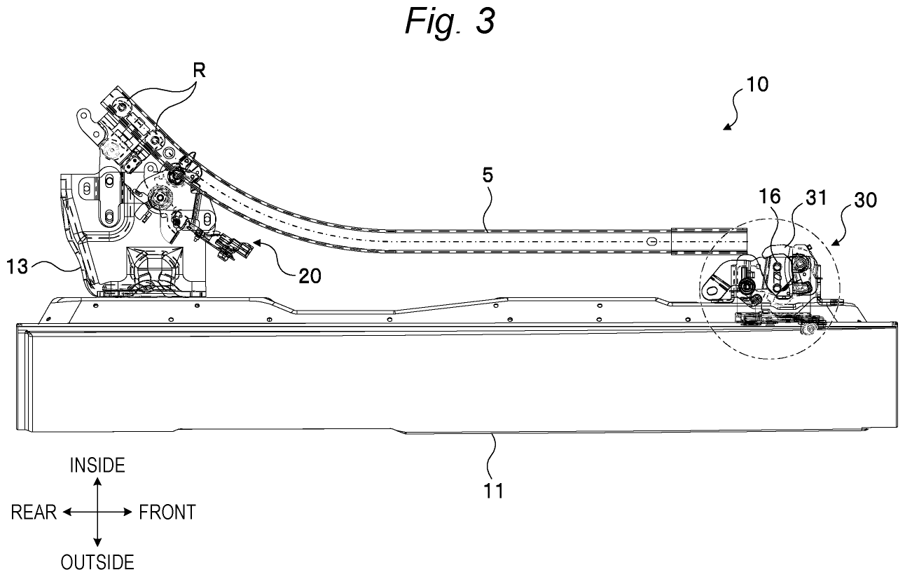

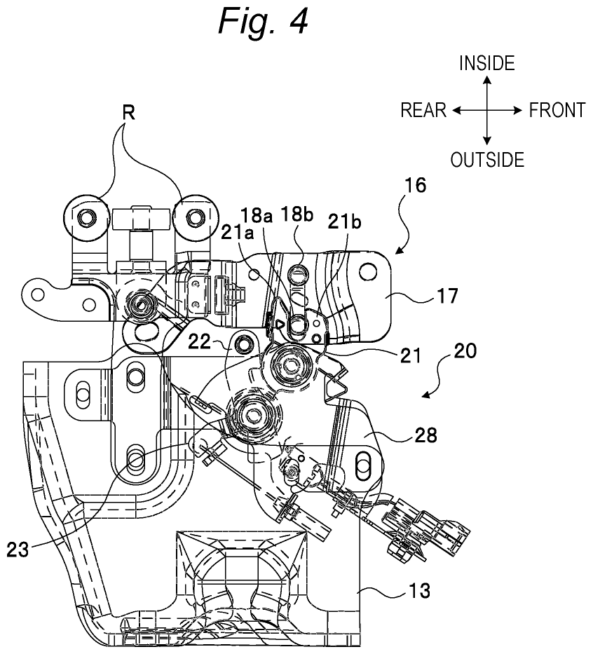

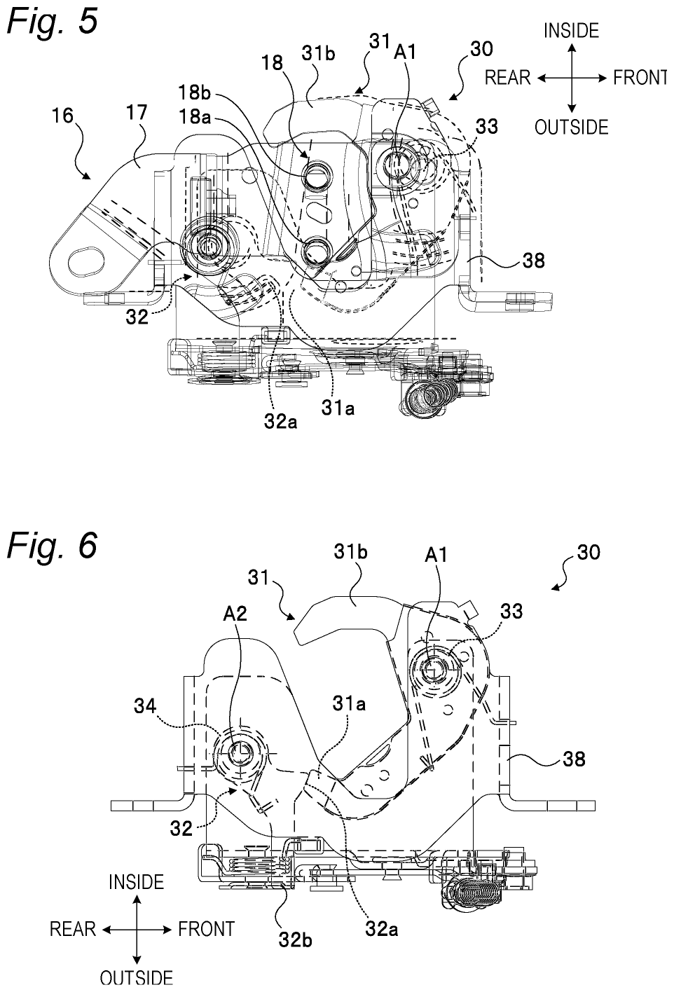

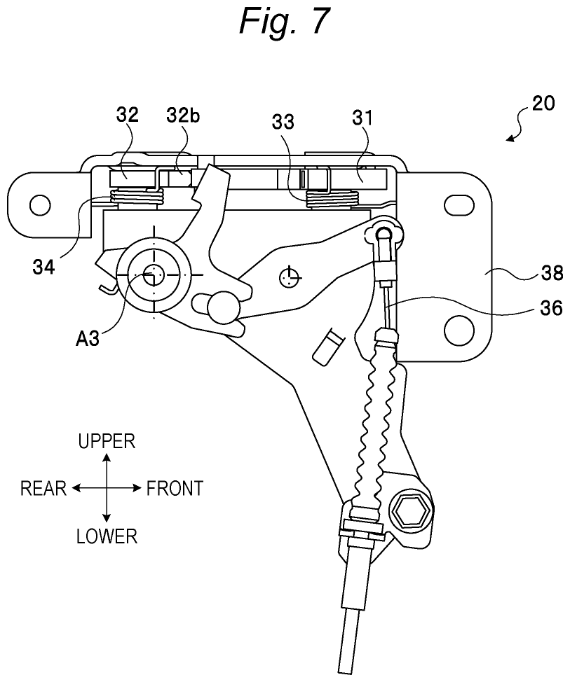

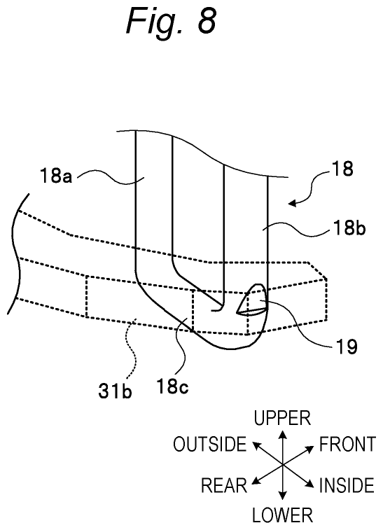

FIG. 1 is a schematic view of a vehicle 1 including a slide door device 10 of the present embodiment, FIG. 2 is a plan view of the slide door device 10 when fully opened when viewed in the vertical direction of the vehicle 1, FIG. 3 is a plan view of the slide door device 10 when fully closed when viewed in the vertical direction of the vehicle 1, FIG. 4 is a partially enlarged view of the slide door device of FIG. 2, and FIG. 5 is a partially enlarged view of the slide door device of FIG. 3. FIG. 6 is a top view of an upper hook device 30, FIG. 7 is a side view of the upper hook device 30, and FIG. 8 is a partially enlarged view of a striker 16 engaged with the upper hook device 30.

The slide door device 10 of the present embodiment opens and closes a door opening 3 by sliding a pair of front and rear slide doors 11 and 12 in directions approaching and separating from each other with respect to the door opening 3 formed at the side face of the vehicle body 2. As illustrated in FIG. 1, the slide door device 10 includes a striker 14, a full-close lock device 15, a striker 16, a full-open lock device 20, and an upper hook device 30 in addition to the pair of front and rear slide doors 11 and 12.

As shown in FIG. 1, respective rails 5 extending in the front-rear direction are installed at an upper edge and a lower edge of a front half of the door opening 3, and a rail 6 extending forward from an intermediate portion in the vertical direction is installed at a front edge of the door opening 3. As illustrated in FIGS. 2 and 3, a roller R is provided via a support member 13 in each of an upper portion and a lower portion at the rear end of the front slide door 11, and a roller R (not illustrated) is provided at an intermediate portion at the front end in the vertical direction via a support member. The slide door 11 slides back and forth as respective rollers R roll on the rails 5 and 6.

Further, respective rails 5 extending in the front-rear direction are installed at an upper edge and a lower edge of a rear half of the door opening 3, and a rail 6 extending rearward from an intermediate portion in the vertical direction is installed at a rear edge of the door opening 3. A roller R (not illustrated) is provided at each of an upper portion and a lower portion at the front end of the rear slide door 12 via a support member, and a roller R (not illustrated) is provided at an intermediate portion at the rear end in the vertical direction via a support member. The slide door 12 slides back and forth as respective rollers R roll on the rails 5 and 6.

The striker 14 is fixed to one face of the opposing faces of the pair of front and rear slide doors 11 and 12.

The full-close lock device 15 is provided at the other face of the opposing faces of the pair of front and rear slide doors 11 and 12, and couples and locks the slide doors 11 and 12 when the slide doors 11 and 12 are fully closed. Although not illustrated, the full-close lock device 15 includes a latch that can be engaged with the striker 14, a pole that engages with the latch to regulate the rotation of the latch, and a release lever for releasing the engagement between the latch and the pole.

The full-open lock device 20 is provided at each of the slide doors 11 and 12. One full-open lock device 20 is provided at the upper part and the rear end of the front slide door 11, and the other full-open lock device 20 is provided at the upper part and the front end of the rear slide door 12. When the slide doors 11 and 12 are fully opened, the full-open lock device 20 engage with a corresponding striker 16 of the two strikers 16 fixed to both ends of the upper edge of the door opening 3 in the front-rear direction to lock the slide doors 11 and 12 in a fully opened state.

The two strikers 16 each include a base member 17 fixed to the vehicle body 2 and a striker body 18 supported by the base member 17. As illustrated in FIG. 8, the striker body 18 is a substantially U-shaped member including a pair of legs 18a and 18b extending in parallel to each other and a coupling portion 18c coupling distal ends of the pair of legs 18a and 18b. The proximal ends of the pair of legs 18a and 18b are fixed to the base member 17. Further, a notch 19 is formed at a side face of the leg 18b on the vehicle interior side. Each striker 16 is fixed to the upper edge of the door opening 3 such that the pair of legs 18a and 18b extends in the vertical direction and is disposed side by side in a direction from the vehicle interior side toward the vehicle exterior side.

As illustrated in FIGS. 2 and 4, the full-open lock device 20 includes a base member 28 fixed to the support member 13 of the slide door 11, a latch 21 that is rotatable with respect to the base member 28 and is engageable with the striker 16 when the slide door 11 is fully opened, a pole 22 that is rotatable with respect to the base member 28 and is engaged with the latch 21 to regulate the rotation of the latch 21, and a release lever 23 that releases the engagement between the latch 21 and the pole 22. The latch 21 includes two hook portions 21a and 21b that extend at a distance slightly wider than the outer diameter of the leg 18a of the striker 16, and sandwich and engage the leg 18a. The latch 21 is biased clockwise in the drawing by a spring, and rotates counterclockwise as the leg 18a of the striker 16 presses one hook portion 21a when the slide doors 11 and 12 are fully opened. By further rotating the latch 21 counterclockwise so that the pole 22 engages with the latch 21, the leg 18a of the striker 16 is sandwiched between the two hook portions 21a and 21b, and the slide doors 11 and 12 are locked in the fully opened state.

The upper hook device 30 is provided in each of the slide doors 11 and 12. The one upper hook device 30 is provided at the upper part and the front end of the front slide door 11 (the end opposite to the end at which the one full-open lock device 20 is provided in the front-rear direction), and the other upper hook device 30 is provided at the upper part and the rear end of the rear slide door 12 (the end opposite to the end at which the other full-open lock device 20 is provided in the front-rear direction). When the slide doors 11 and 12 are fully closed, each of the upper hook devices 30 is engaged with the corresponding striker 16 of the two strikers 16 described above to regulate displacement of each of the slide doors 11 and 12 from the vehicle interior side to the vehicle exterior side.

As illustrated in FIGS. 5 to 7, the upper hook device 30 includes a base member 38, a latch 31 that is rotatable with respect to the base member 38 and is engageable with the striker 16 when the slide doors 11 and 12 are fully closed, a pole 32 that is rotatable with respect to the base member 38 and is engaged with the latch 31 to regulate the rotation of the latch 31, and a release lever 35 that releases the engagement between the pole 32 and the latch 31. In the present embodiment, the striker 16 with which the latch 31 of the upper hook device 30 is engaged is shared with the striker 16 with which the latch 21 of the full-open lock device 20 described above is engaged. Therefore, the number of components can be reduced to further reduce the cost.

As illustrated in FIGS. 5 and 6, the latch 31 includes a rotation shaft A1 that extends in the vertical direction of the vehicle body 2 and is rotatably supported by the base member 38, and two hook portions 31a and 31b that extend at a distance wider than the distance between the pair of legs 18a and 18b of the striker 16 and are bent such that their distal ends approach each other. That is, the latch 31 has a substantially C shape when viewed in the direction of the rotation shaft A1. Further, a spring 33 is provided at the rotation shaft A1 of the latch 31, and the latch 31 is biased clockwise in the drawing by the spring 33.

As illustrated in FIGS. 5 and 6, the pole 32 includes a rotation shaft A2 that extends in parallel with the rotation shaft A1 and is rotatably supported by the base member 38, a latch engagement portion 32a that engages with one hook portion 31a of the latch 31, and a release lever engagement portion 32b that engages with the release lever 35. A spring 34 is provided at the rotation shaft A2 of the pole 32, and the pole 32 is biased counterclockwise in the drawing by the spring 34.

As illustrated in FIG. 7, the release lever 35 includes a rotation shaft A3 that extends in a direction orthogonal to the rotation shafts A1 and A2 and is rotatably supported by the base member 38, and a pole engagement portion 35a that engages with the release lever engagement portion 32b of the pole 32. A spring is provided at the rotation shaft A3 of the release lever 35, and the release lever 35 is biased clockwise in the drawing by the spring. When a release cable 36 is pulled by a motor (not illustrated) in a state where the latch 31 and the pole 32 are engaged, the release lever 35 rotates counterclockwise in FIG. 7. When the release lever 35 rotates counterclockwise, the pole 32 rotates clockwise in FIG. 6. As a result, the engagement between the latch 31 and the pole 32 is released.

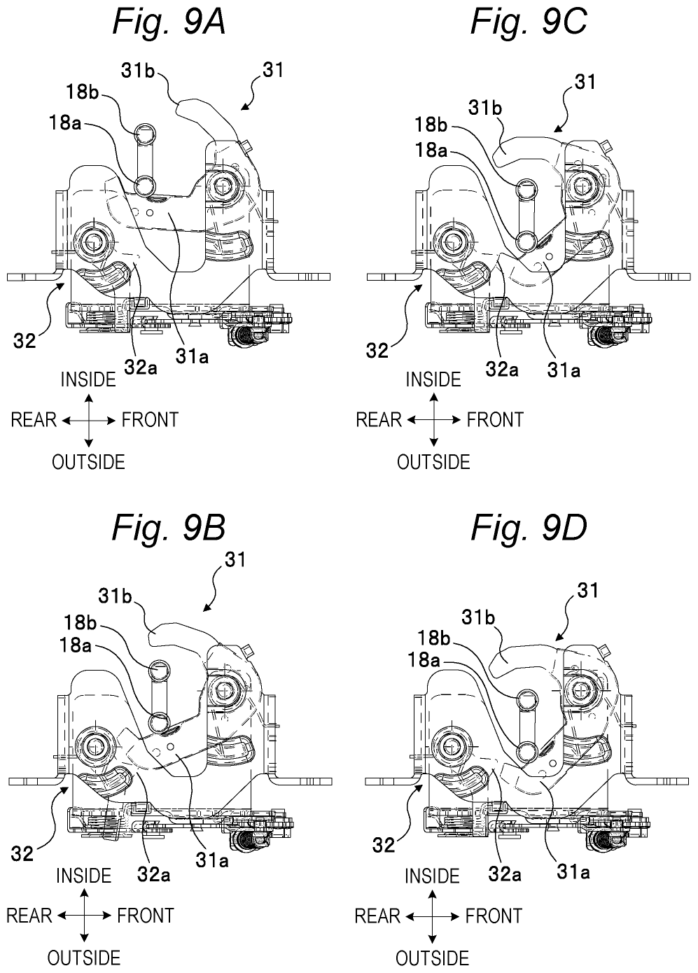

In the upper hook device 30 configured as described above, when the slide doors 11 and 12 are fully closed, first, one hook portion 31a of the latch 31 on the vehicle exterior side comes into contact with one leg 18a of the striker 16 on the vehicle exterior side (striker body 18) (see FIG. 9A). When the slide doors 11 and 12 further slide in the closing direction, the one hook portion 31a of the latch 31 is pressed against the one leg 18a of the striker 16, and the latch 31 rotates counterclockwise in the drawing (see FIG. 9B). When the latch 31 rotates, the other hook portion 31b of the latch 31 on the vehicle interior side goes around the other leg 18b of the striker 16 on the vehicle interior side, and the one hook portion 31a of the latch 31 is engaged with the latch engagement portion 32a of the pole 32 (see FIG. 9C). Then, the slide doors 11 and 12 are fully closed in a state where the other hook portion 31b goes around the other leg 18b of the striker 16 (see FIG. 9D). As a result, even when the slide doors 11 and 12 are pressed from the vehicle interior side to the vehicle exterior side, the other hook portion 31b is engaged with the other leg 18b of the striker 16, and the displacement of the slide doors 11 and 12 to the vehicle exterior side is regulated. As described above, when the slide doors 11 and 12 are fully closed, the latch 31 automatically goes around the vehicle interior side of the striker 16 and is brought into a state of being engageable with the striker 16, so that displacement of the slide doors 11 and 12 from the vehicle interior side to the vehicle exterior side can be more reliably regulated. As a result, safety of the occupant can be ensured. In addition, as illustrated in FIG. 8, since the other leg 18b of the striker 16 on the vehicle interior side has the notch 19, when the slide doors 11 and 12 are displaced from the vehicle interior side to the vehicle exterior side and the other hook portion 31b comes into contact with the other leg 18b, the other hook portion 31b is engaged with the notch 19 as illustrated in FIG. 8, so that it is possible to prevent the engagement deviation and more reliably prevent the slide doors 11 and 12 from being displaced from the vehicle interior side to the vehicle exterior side.

In the embodiment described above, the slide doors 11 and 12 are provided in the form of a pair of front and rear doors, and slide so as to approach and be away from each other with respect to the vehicle body 2 to open and close the door opening 3, but the slide door may be a single slide door, and may slide backward with respect to the door opening 3 to open and close the door opening 3.

In the embodiment described above, the full-open lock device 20 and the upper hook device 30 are installed at the upper part of the slide doors 11 and 12, but may be installed at the lower part of the slide doors 11 and 12.

In the above-described embodiment, the latch 21 of the full-open lock device 20 and the latch 31 of the upper hook device 30 are engaged with the same striker 16, but may be engaged with separate strikers.

In a slide door device including a slide door that opens and closes a door opening formed at a side face of a vehicle body by sliding the door opening in a vehicle front-rear direction, the slide door device includes a striker fixed to an opening edge of the door opening, and a first latch that is fixed to an end of the slide door, the end facing the opening edge, when the slide door is fully closed, is pressed by the striker to rotate when the slide door is fully closed, and is engageable with a leg of the striker in a direction from a vehicle interior side toward a vehicle exterior side.

The slide door device of the present disclosure includes a first latch that is pressed by the striker to rotate when the slide door is fully closed, and is engageable with a leg of the striker in a direction from the vehicle interior side toward the vehicle exterior side. Since the first latch is brought into a state of being automatically engageable with the striker when the slide door is fully closed, displacement (opening) of the slide door from the vehicle interior side to the vehicle exterior side can be more reliably suppressed. As a result, safety of the occupant can be ensured.

The slide door device includes a second latch that is fixed to another end of the slide door, the another end facing the opening edge, when the slide door is fully opened, and is allowed to lock the slide door by engaging with a leg of the striker, wherein the striker is shared by the first latch and the second latch.

In the slide door device, the leg has a notch at a side face thereof, and the first latch is engageable with the notch of the leg.

In the slide door device, the striker is disposed such that a pair of legs extends in parallel in a vehicle vertical direction and is disposed side by side in a direction from a vehicle interior side toward a vehicle exterior side, and wherein the first latch includes a pair of hook portions that is rotatable about a rotation shaft extending in the vehicle vertical direction as a fulcrum and extends at a distance wider than a distance between the pair of legs, one hook portion of the pair of hook portions is pressed by one leg of the pair of legs to rotate and the other hook portion goes around the vehicle interior side of the other leg when the slide door is fully closed, so that the first latch is brought into a state of being engageable in a direction from the vehicle interior side toward the vehicle exterior side.

The present disclosure is applicable to a manufacturing industry of a slide door device. The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A slide door device including a slide door that opens and closes a door opening formed at a side face of a vehicle body by sliding the door opening in a vehicle front-rear direction,
the slide door device comprising:
a striker fixed to an opening edge of the door opening; and
a first latch that is fixed to an end of the slide door, the end facing the opening edge, when the slide door is fully closed, is pressed by the striker to rotate when the slide door is fully closed, and is engageable with a leg of the striker in a direction from a vehicle interior side toward a vehicle exterior side.

2. The slide door device according to claim 1, further comprising:
a second latch that is fixed to another end of the slide door, the another end facing the opening edge, when the slide door is fully opened, and is allowed to lock the slide door by engaging with a leg of the striker, wherein
the striker is shared by the first latch and the second latch.

3. The slide door device according to claim 1, wherein
the leg has a notch at a side face thereof, and wherein
the first latch is engageable with the notch of the leg.

4. The slide door device according to claim 2, wherein
the leg has a notch at a side face thereof, and wherein
the first latch is engageable with the notch of the leg.

5. The slide door device according to claim 1, wherein
the striker is disposed such that a pair of legs extends in parallel in a vehicle vertical direction and is disposed side by side in a direction from a vehicle interior side toward a vehicle exterior side, and wherein
the first latch includes a pair of hook portions that is rotatable about a rotation shaft extending in the vehicle vertical direction as a fulcrum and extends at a distance wider than a distance between the pair of legs, one hook portion of the pair of hook portions is pressed by one leg of the pair of legs to rotate and the other hook portion goes around the vehicle interior side of the other leg when the slide door is fully closed, so that the first latch is brought into a state of being engageable in a direction from the vehicle interior side toward the vehicle exterior side.

6. The slide door device according to claim 2, wherein
the striker is disposed such that a pair of legs extends in parallel in a vehicle vertical direction and is disposed side by side in a direction from a vehicle interior side toward a vehicle exterior side, and wherein
the first latch includes a pair of hook portions that is rotatable about a rotation shaft extending in the vehicle vertical direction as a fulcrum and extends at a distance wider than a distance between the pair of legs, one hook portion of the pair of hook portions is pressed by one leg of the pair of legs to rotate and the other hook portion goes around the vehicle interior side of the other leg when the slide door is fully closed, so that the first latch is brought into a state of being engageable in a direction from the vehicle interior side toward the vehicle exterior side.
